(19) United States
(12) Patent Application Publication
(10) Pub. No.: US 2007/0123130 A1
(43) Pub. Date: May 31, 2007

(54) MULTIPLE-LAYER, MULTIPLE-DENIER NONWOVEN FIBER BATT

(75) Inventors: Jesse Manuel, Eden, NC (US); Mike Francisco, Concord, NC (US)

Correspondence Address: CONLEY ROSE, P.C., 5700 GRANITE PARKWAY, SUITE 330, PLANO, TX, 75024, US

(73) Assignee: L&P Property Management Company, South Gate, CA (US)

(21) Appl. No.: 11/559,665

(22) Filed: Nov. 14, 2006

Related U.S. Application Data
(60) Provisional application No. 60/736,809, filed on Nov. 14, 2005.

(51) Int. Cl. B32B 5/26; B32B 7/02

(52) U.S. Cl. 442/381; 428/213; 442/346

(57) ABSTRACT

A nonwoven fiber product comprises a coarse fiber web comprising a plurality of coarse fibers and substantially free of any fine fibers, and a fine fiber web comprising a plurality of the fine fibers and substantially free of any of the coarse fibers, wherein the coarse fiber web is positioned adjacent to the fine fiber web. A method of making a nonwoven fiber product comprises blending a plurality of coarse fibers into a coarse fiber blend that is substantially free of fine fibers, blending a plurality of fine fibers into a fine fiber blend that is substantially free of coarse fibers, forming the coarse fiber blend into a coarse fiber web, and forming the fine fiber blend into a fine fiber web, wherein the fine fiber web is formed adjacent to the coarse fiber web.

### CROSS-REFERENCE TO RELATED APPLICATIONS

The present application claims the benefit under 35 U.S.C. § 119(e) of U.S. Provisional Application Ser. No. 60/736,809 filed Nov. 14, 2005 and entitled “Multiple-Layer, Multiple-Denier Nonwoven Fiber Batt”, hereby incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates generally to nonwoven fiber batts for use as filter media, methods for manufacturing such nonwoven fiber batts, and methods for filtering a fluid with such nonwoven fiber batts. More particularly, the present invention relates to nonwoven fiber batts comprising a plurality of fiber web layers wherein each layer comprises a unique fiber composition.

### BACKGROUND

Filter media are used in various applications to filter particles out of gases or liquids (collectively, fluids). Several different types of filter media are currently available, including nonwoven fiber batts and polyurethane foam. Each type of filter media provides its own specific advantages, but over time, all filters eventually become clogged or “loaded” with the particles that are filtered out of the fluids. As a filter becomes fully loaded, the filtration operation is hindered because the filter unacceptably obstructs the flow of fluid passing through the filter media, or it is no longer effective at removing particles from the fluid, or both. Thus, a fully loaded filter has to be replaced for normal filtration to continue.

Various improvements have been made to filter media to increase filter life and/or loading capacity, such as forming a three-dimensional shape on the leading or internal surface of the filter media, for example, to increase its surface area and thereby increase its loading capacity. However, such improvements also significantly increase the complexity of the filter media manufacturing process. Thus, a need exists for a filter media with an increased filter life and/or loading capacity that is relatively easy to manufacture.

### SUMMARY OF THE INVENTION

In one aspect, the present disclosure is directed to a nonwoven fiber product comprising a coarse fiber web comprising a plurality of coarse fibers and substantially free of any fine fibers, and a fine fiber web comprising a plurality of the fine fibers and substantially free of any of the coarse fibers, wherein the coarse fiber web is positioned adjacent to the fine fiber web. In an embodiment, the coarse fiber web and the fine fiber web each comprise substantially flat surfaces. The plurality of coarse fibers may comprise one or more coarse fiber types and the plurality of fine fibers may comprise one or more fine fiber types. In various embodiments, the coarse fibers have a weight per unit length of at least about 30 denier, between about 50 denier and about 200 denier, or between about 75 denier and about 125 denier. In various embodiments, the fine fibers have a weight per unit length of at most about 30 denier, between about 0.1 denier and about 20 denier, or between about 1 denier and about 8 denier. The amount of fibers in the coarse fiber web may be between about 10 percent and about 100 percent of the amount of fibers in the fine fiber web. In an embodiment, the nonwoven fiber product has a fiber denier gradient. In another aspect, the present disclosure is directed to a filtration media comprising the nonwoven fiber product. In an embodiment, the filtration efficiency of the nonwoven fiber product is at least about 99 percent.

In yet another aspect, the present disclosure is directed to a method of making a nonwoven fiber product, the method comprising blending a plurality of coarse fibers into a coarse fiber blend that is substantially free of fine fibers, blending a plurality of fine fibers into a fine fiber blend that is substantially free of coarse fibers, forming the coarse fiber blend into a coarse fiber web, and forming the fine fiber blend into a fine fiber web, wherein the fine fiber web is formed adjacent to the coarse fiber web. In an embodiment, the plurality of coarse fibers comprises one or more coarse fiber types and the plurality of fine fibers comprises one or more fine fiber types. The method may further comprise bonding the coarse fibers in the coarse fiber web and bonding the fine fibers in the fine fiber web. In various embodiments, bonding comprises resin bonding, mechanical bonding or thermal bonding. The method may further comprise bonding at least a portion of the coarse fiber web to at least a portion of the fine fiber web. In anther embodiment, the method further comprises compressing the coarse fiber web and the fine fiber web together.

In still another aspect, the present disclosure is directed to a method for filtering a fluid, the method comprising passing a fluid comprising a plurality of particles through a coarse fiber web, and passing the fluid through a fine fiber web positioned adjacent to the coarse fiber web, wherein the coarse fiber web and the fine fiber web collectively remove at least about 99 percent of the particles from the fluid.

### BRIEF DESCRIPTION OF THE DRAWINGS

For a more complete understanding of the present invention, and for further details and advantages thereof, reference is now made to the accompanying drawings, in which:

FIG. 1 is a schematic side view of one embodiment of a multiple-layer, multiple-denier nonwoven fiber batt;

FIG. 2 depicts one representative operational environment for a multiple-layer, multiple-denier nonwoven fiber batt in a filtration application;

FIG. 3 is a block diagram of one representative method for manufacturing a multiple-layer, multiple-denier nonwoven fiber batt;

FIG. 4 is a schematic top plan view of one embodiment of a general processing line for manufacturing a multiple-layer, multiple-denier nonwoven fiber batt in accordance with the method of FIG. 3;

FIG. 5A is a side view of one embodiment of a heating and compression apparatus for manufacturing a multiple-layer, multiple-denier nonwoven fiber batt in accordance with the method of FIG. 3;

FIG. 5B is a side view of an alternative embodiment of a heating and compression apparatus for manufacturing a multiple-layer, multiple-denier nonwoven fiber batt in accordance with the method of FIG. 3; and

FIG. 6 is a paint arrestance filter test report for a multiple-layer, multiple-denier nonwoven fiber batt.

### DETAILED DESCRIPTION

Various embodiments of multiple-layer, multiple-denier nonwoven fiber batts; methods of using such nonwoven fiber batts as filter media; and methods of manufacturing such nonwoven fiber batts will now be described with reference to the accompanying drawings, wherein like reference numerals are used for like features throughout the several views.

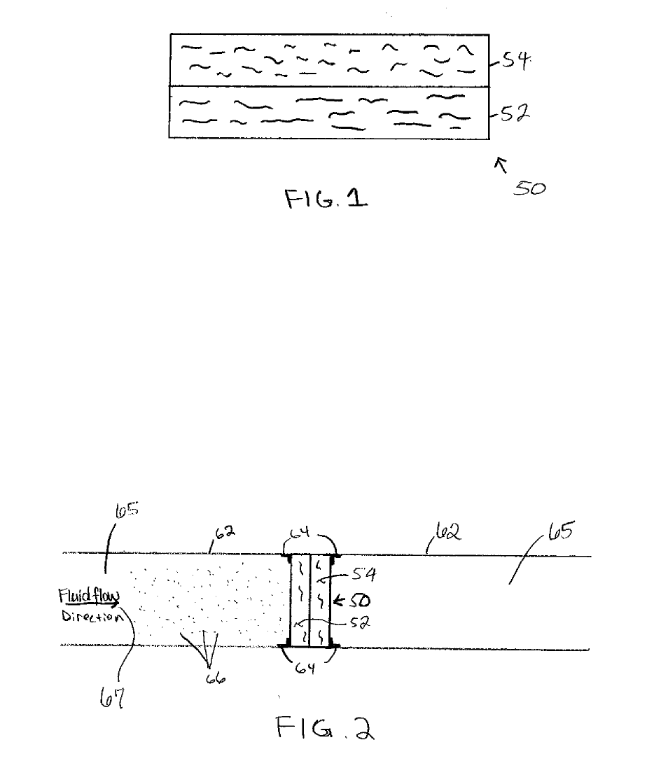

FIG. 1 depicts one embodiment of a multiple-layer, multiple-denier nonwoven fiber batt 50 comprising a coarse fiber web 52 and a fine fiber web 54. The coarse fiber web 52 comprises a plurality of coarse fibers formed into approximately a homogeneous coarse fiber blend. Similarly, the fine fiber web 54 comprises a plurality of fine fibers formed into approximately a homogeneous fine fiber blend. As described in further detail below, the coarse fibers in the coarse fiber web 52 and the fine fibers in the fine fiber web 54 may be bonded to each other and to at least some of the fibers in the adjacent fiber web to form the multiple-layer, multiple-denier nonwoven fiber batt 50.

The coarse fibers in the coarse fiber web 52 are fibers having a relatively large weight per unit length as compared to the fine fibers in the fine fiber web 54. The coarse fibers may be natural fibers, such as cotton, wool, or silk, or may be synthetic fibers, such as polyester, nylon, or polypropylene. In various embodiments, the coarse fibers have a weight per unit length of at least about 30 denier, between about 50 and about 200 denier, or between about 75 and about 125 denier.

The coarse fiber blend of the coarse fiber web 52 may comprise a single fiber type, such as Wellstrand® type 944 fibers with a nominal weight per unit length of 100 denier, available from Wellman, Incorporated of Fort Mill, S.C., or may comprise a combination of different fiber types, such as the aforementioned Wellstrand® type z/944 fibers combined with KoSa type 293 fibers with a nominal weight per unit length of 32 denier, available from KoSa of Wichita, Kans., for example. If the coarse fiber blend is a combination of different fiber types, the coarse fiber blend may comprise any of a number of suitable blend compositions. In one embodiment, the coarse fiber blend comprises one fiber type in the range of about five percent to about 95 percent by weight of the blend with another fiber type representing the remaining about 95 percent to about five percent by weight of the fiber blend. In another embodiment, the coarse fiber blend comprises one fiber type in the range of about 50 percent by weight and another fiber type in the range of about 50 percent by weight. Moreover, the coarse fiber web 52 may comprise other embodiments of coarse fiber blends, such as fiber blends with more than two different fiber types and fiber blends of different blend compositions. Therefore, the coarse fiber blends and fiber blend compositions should not be limited by the specific embodiments disclosed herein.

The fine fibers in the fine fiber web 54 are fibers with a relatively small weight per unit length when compared to the coarse fibers in the coarse fiber web 52. The fine fibers may be either natural fibers, such as cotton, wool, or silk, or may be synthetic fibers, such as polyester, nylon, or polypropylene. In embodiments, the fine fibers have a weight per unit length of at most about 60 percent, at most about 15 percent, or at most about 5 percent of the weight per unit length of the coarse fibers. In other embodiments, the fine fibers have a weight per unit length of at most about 30 denier, between about 0.1 and about 20 denier, or between about 1 and about 8 denier.

The fine fiber blend of the fine fiber web 54 may comprise a single fiber type, such as KoSa type 295 fibers with a weight per unit length of 6 denier, or may comprise a combination of different fiber types, such as the aforementioned KoSa type 295 fibers and Impet® polyester fibers available from the Celanese Corporation of Dallas, Tex., for example. If the fine fiber blend is a combination of different fiber types, the fine fiber blend may comprise any of a number of suitable blend compositions. In one embodiment, the fine fiber blend comprises one fiber type in the range of about five percent to about 95 percent by weight of the blend with another fiber type representing the remaining about 95 percent to about five percent by weight of the fiber blend. In another embodiment, the fine fiber blend comprises one fiber type in the range of about 50 percent by weight and another fiber type in the range of about 50 percent by weight. Moreover, the fine fiber web 54 may comprise other embodiments of fine fiber blends, such as fiber blends with more than two different fiber types and fiber blends of different blend compositions. Therefore, the fine fiber blends and fiber blend compositions should not be limited by the specific embodiments disclosed herein.

Within a single multiple-layer, multiple-denier nonwoven fiber batt 50, the physical properties of the coarse fiber web 52 may differ from the physical properties of the fine fiber web 54. For example, it is contemplated that the coarse fiber web 52 may have the same thickness, or a larger or smaller thickness, than the fine fiber web 54. In specific embodiments, the thickness of the coarse fiber web 52 may be at least about 1 percent, between about 10 percent and about 500 percent, or between about 40 percent and about 100 percent of the thickness of the fine fiber web 54. Moreover, the coarse fiber web 52 may have the same weight per unit area, or a higher or lower weight per unit area, than the fine fiber web 54. In specific embodiments, the weight per unit area of the coarse fiber web 52 may be at least about 1 percent, between about 10 percent and about 500 percent, or between about 40 percent and about 100 percent of the weight per unit area of the fine fiber web 54. Furthermore, the coarse fiber web 52 may contain the same amount of fibers by weight or by volume, or a larger or smaller amount of fibers by weight or by volume, than the fine fiber web 54. In specific embodiments, the amount of fibers in the coarse fiber web 52 may be at least about 1 percent, between about 5 percent and about 500 percent, or between about 10 percent and about 100 percent of the amount of fibers in the fine fiber web 54.

The total thickness and weight per unit area of the multiple-layer, multiple-denier nonwoven fiber batt 50 will affect its performance in a particular application. For example, in filtration applications the thickness of the multiple-layer, multiple-denier nonwoven fiber batt 50 will affect the filtration efficiency, loading capacity, and change in pressure of the fluid as it passes therethrough. Thicker multiple-layer, multiple-denier nonwoven fiber batts 50 will have higher filtration efficiencies, higher loading capacities, and higher pressure changes as compared to thinner batts 50, which will have lower filtration efficiencies, lower loading capacities, and lower pressure changes. In specific embodiments, the thickness of the multiple-layer, multiple-denier nonwoven fiber batt 50 is at least about 0.25 inches, between about 0.5 inches and about 6 inches, or between about 1 inch and about 3 inches. Similarly, multiple-layer, multiple-denier nonwoven fiber batts 50 with higher weights per unit area will serve to decrease the size of particles filtered from the fluid stream, but also increase the pressure drop across the multiple-layer, multiple-denier nonwoven fiber batt 50 as compared to batts 50 with lower weights per unit area. In specific embodiments, the weight per unit area of the multiple-layer, multiple-denier nonwoven fiber batt 50 is between about 0.25 ounces per square foot and about 12 ounces per square foot, between about 0.5 ounces per square foot and about 6 ounces per square foot, or between about 1 ounce per square foot and about 3 ounces per square foot. When selecting a multiple-layer, multiple-denier nonwoven fiber batt 50 for a particular application, a balance must be struck between the filtering performance and the pressure drop of the fluid being filtered as it passes therethrough. Thus, a person of ordinary skill in the art can best select the appropriate combination of thickness and weight per unit area suitable for a particular application.

In one embodiment, the coarse fiber web 52 and the fine fiber web 54 are bonded together and/or to each other by a resin. The resin may comprise polyvinyl acetate (PVA) or any other polymeric or adhesive composition, such as vinyldiene chloride copolymer, latex, acrylic, or other suitable chemical compounds, for example. One suitable resin is the SARAN™ 506 resin available from the Dow Chemical Company of Midland, Mich. The resin may also contain antimicrobial, antifungal, or hydrophobic additives that further enhance the properties of the multiple-layer, multiple-denier nonwoven fiber batt 50. The resin may be used alone or may be mixed with water prior to application of the resin to the fibers to improve the density, viscosity, and application properties of the resin to the fibers. In embodiments using a PVA resin, the amount of water mixed with the resin is at least about 5 percent by weight, between about 20 percent and about 75 percent by weight, or between about 30 percent and 55 percent by weight.

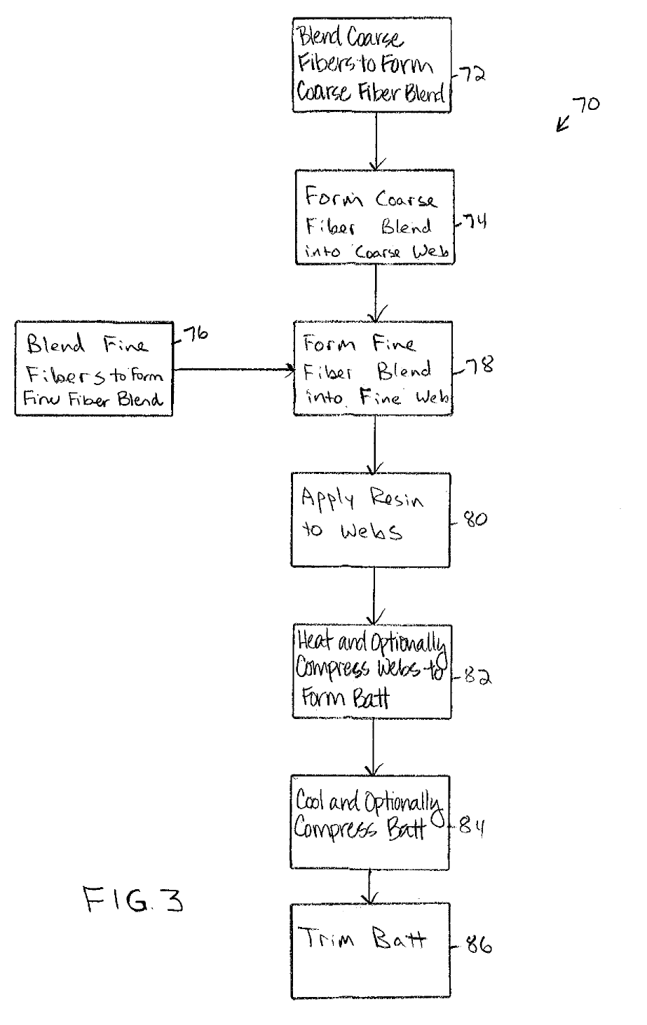

FIG. 2 illustrates one representative operational environment for the multiple-layer, multiple-denier nonwoven fiber batt 50 in a filtration application. A fluid 65, such as air, for example, is shown flowing in the direction of the flow arrow 67 through a conduit 62 within which the multiple-layer, multiple-denier nonwoven fiber batt 50 is secured by a plurality of supports 64. The nonwoven fiber batt 50 is thus disposed internally of the conduit 62 in a fixed position with the coarse fiber web 52 positioned upstream of the fine fiber web 54, as shown in FIG. 2. However, it is also contemplated that the coarse fiber web 52 may be positioned downstream of the fine fiber web 54 in other embodiments.

As shown in FIG. 2, the fluid 65 contains a plurality of suspended particles 66 as the fluid 65 flows through the conduit 62 towards the multiple-layer, multiple-denier nonwoven fiber batt 50. The particles 66 may be solid, such as dust, dirt, or debris, or may be liquid, such as water, oil, or paint. As the fluid 65 passes through the multiple-layer, multiple-denier nonwoven fiber batt 50, the particles 66 of larger size become entrapped within the coarse fiber web 52 while the particles 66 of smaller size become entrapped within the fine fiber web 54. Similar to nonwoven fiber batts with three-dimensional surfaces, it is believed that the large diameter of the coarse fibers in the coarse fiber web 52 create a tortuous path for the fluid 65 and the smaller particles 66 to flow through while acting as a filtration material for the larger particles 66.

The combination of the aforementioned effects allow the multiple-layer, multiple-denier nonwoven fiber batt 50, which has substantially flat surfaces, to achieve filtration efficiencies comparable to nonwoven fiber batts having three-dimensional leading edge surfaces or internal surface boundaries that are more complex to manufacture. Filtration efficiency is the amount of particles 66 retained in the multiple-layer, multiple-denier nonwoven fiber batt 50 as a percentage of the total number of particles 66 in the fluid 65. In various embodiments, the multiple-layer, multiple-denier nonwoven fiber batt 50 achieves filtration efficiencies of at least 95 percent, at least 99 percent, or at least 99.4 percent.

In alternative embodiments, a multiple-layer, multiple-denier nonwoven fiber batt 50 may be used in other applications besides the filtration operation depicted in FIG. 2. For example, the multiple-layer, multiple-denier nonwoven fiber batt 50 may be used in lieu of any nonwoven fiber product in applications such as bedding, furniture, quilting, clothing, fiberfill, and the like. Persons of ordinary skill in the art will readily appreciate that the multiple-layer, multiple-denier nonwoven fiber batt 50 may be used in many different applications other than those specifically described herein.

Referring now to FIG. 3, a block diagram outlines one method 70 for making a multiple-layer, multiple-denier nonwoven fiber batt 50. The method 70 commences at 72 where the coarse fibers are blended to form approximately a homogeneous coarse fiber blend. At 74, the coarse fiber blend is formed into the coarse fiber web 52. At 76, independent of 72 and 74, the fine fibers are blended to form approximately a homogeneous fine fiber blend. At 78, the fine fiber blend is formed into the fine fiber web 54. At 80, the coarse fiber web 52 and the fine fiber web 54 are each coated with resin. At 82, the fiber webs 52, 54 are then heated and optionally compressed together to form a nonwoven fiber batt. The nonwoven fiber batt is subsequently cooled at 84 and trimmed at 86, thereby forming the multiple-layer, multiple-denier nonwoven fiber batt 50 shown in FIG. 1. Each of these steps is described in greater detail below.

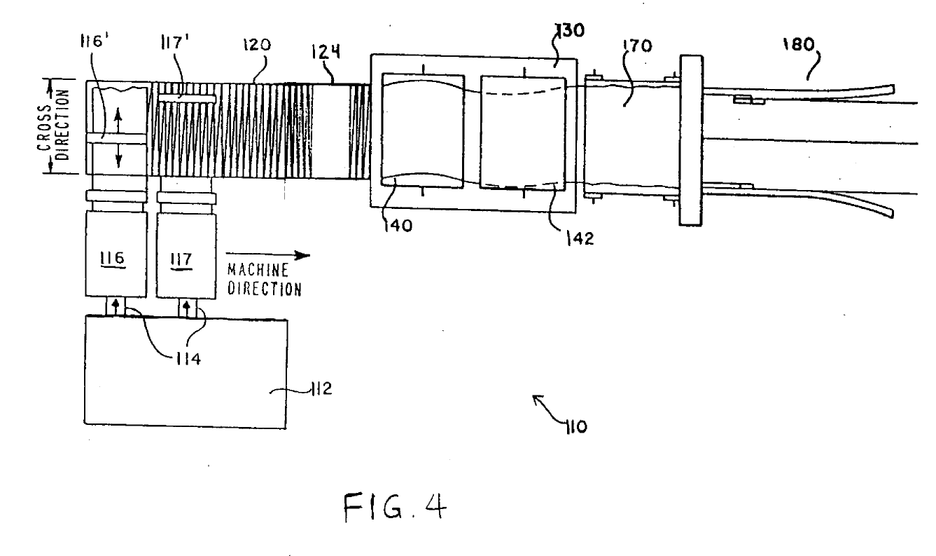

Referring now to FIG. 4, a schematic top plan view of the general processing line 110 for constructing the multiple-layer, multiple-denier nonwoven fiber batt 50 in accordance with the method of FIG. 3 is depicted. The general processing line 110 performs 72 through 86 of method 70. In particular, a fiber blender 112 blends the coarse fibers together per 72 of method 70 and conveyor pipes 114 convey the coarse fiber blend to a web forming machine 116. The fiber blender 112 may subsequently blend the fine fibers together per 76 of method 70 and conveyor pipes 114 convey the fine fiber blend to a separate web forming machine 117. Thus, the fiber blender 112 maintains separation between the coarse fibers and the fine fibers in each of the fiber blends such that the coarse fiber blend is substantially free of fine fibers and the fine fiber blend is substantially free of coarse fibers.

Several types of web forming machines 116, 117 are suitable for the purposes described herein. One suitable web forming apparatus is a garnett machine. In other embodiments, an air laying machine, known in the trade as a Rando webber, or any other suitable apparatus could be used to form a web structure. Garnett machine 116 cards the coarse fiber blend into the coarse fiber web 52 and delivers the coarse fiber web 52 to cross-lapper 116′ to cross-lap the coarse fiber web 52 onto a slat conveyor 120 moving in the machine direction per 74 of method 70. Similarly, garnett machine 117 cards the fine fiber blend into the fine fiber web 54 and delivers the fine fiber web 54 to cross-lapper 117′ to cross-lap the fine fiber web 54 on top of the coarse fiber web 52 on the slat conveyor 120 per 78 of method 70. Of course, it is contemplated that the carding process may be reversed such that the fine fiber web 54 can be positioned on the conveyor 120 first, and the coarse fiber web 52 may subsequently be carded onto the fine fiber web 54. It is also contemplated that the method 70 described herein can be used to create a nonwoven fiber batt 50 with more than two fiber web layers and/or various fiber deniers in the various fiber web layers. In one embodiment, a plurality of such fiber web layers and fiber deniers are arranged to create a fiber denier gradient throughout the multiple-layer, multiple-denier nonwoven fiber batt 50.

Cross-lappers 116′ and 117′ reciprocate back and forth in the cross direction from one side of conveyor 120 to the other side to form webs 52, 54 having multiple sub-layers to form the desired thicknesses in a progressive overlapping relationship. The number of sub-layers that make up each web 52, 54 is determined by the speed of the conveyor 120 in relation to the speed at which successive sub-layers are layered on top of each other and the number of cross-lappers 116′ and 117′. Thus, the number of sub-layers that make up the webs 52, 54 can be increased by slowing the relative speed of the conveyor 120 in relation to the speed at which cross layers are layered, by increasing the number of cross-lappers 116′ and 117′, or both. Conversely, a fewer number of sub-layers can be achieved by increasing the relative speed of conveyor 120 to the speed of laying the cross layers, by decreasing the number of cross-lappers 116′ and 117′, or both. In the present invention, the number of sub-layers which make up the coarse fiber web 52 and the fine fiber web 54 vary depending on the desired thickness and weight per unit area of the multiple-layer, multiple-denier nonwoven fiber batt 50 of the present invention. As a result, the relative speed of the conveyor 120 to the speed at which cross layers are layered and the number of cross-lappers 116′ and 117′ for forming the coarse fiber web 52 and the fine fiber web 54 may vary accordingly.

As the stacked webs 52, 54 move along the conveyor 120 in the machine direction, the resin is applied to the webs 52, 54 by resin applicator 124 per 80 of method 70. There are a variety of techniques suitable for applying resins onto the webs 52, 54. For example, the liquid resin may be mixed with water, if applicable, and sprayed onto the webs 52, 54 from one or more spray heads that move in a transverse or cross direction to substantially coat the webs 52, 54. Alternatively, froth resin can be extruded onto the webs 52, 54 using a knife or other means. The webs 52, 54 can also be fed through or dipped into a resin bath. The applied resin is crushed into the webs 52, 54 for saturation therethrough by nip rollers disposed along the transverse direction of the conveyor to apply pressure to the surface of the batt. Alternatively, the resin is crushed into the webs 52, 54 by vacuum pressure applied through the batt.

The resins described herein are curable by heat and can be any of a variety of compositions as discussed in detail above. In one specific embodiment, a resin comprising about 50 percent by weight of PVA and about 50 percent by weight of water is prepared and sprayed onto the top surface of the fine fiber web 54. In addition, a second resin comprising about 67 percent by weight of PVA and about 33 percent of weight water is prepared and sprayed onto the bottom surface of the coarse fiber web 52, such that the total weight of the two resins on the multiple-layer, multiple-denier nonwoven fiber batt 50 is about 23 percent of the total weight of the multiple-layer, multiple-denier nonwoven fiber batt 50. In various embodiments, the amount of resin applied to the two webs 52, 54 is at least about 1 percent, between about 5 percent and about 50 percent, or between about 15 percent and about 35 percent of the total weight of the multiple-layer, multiple-denier nonwoven fiber batt 50.

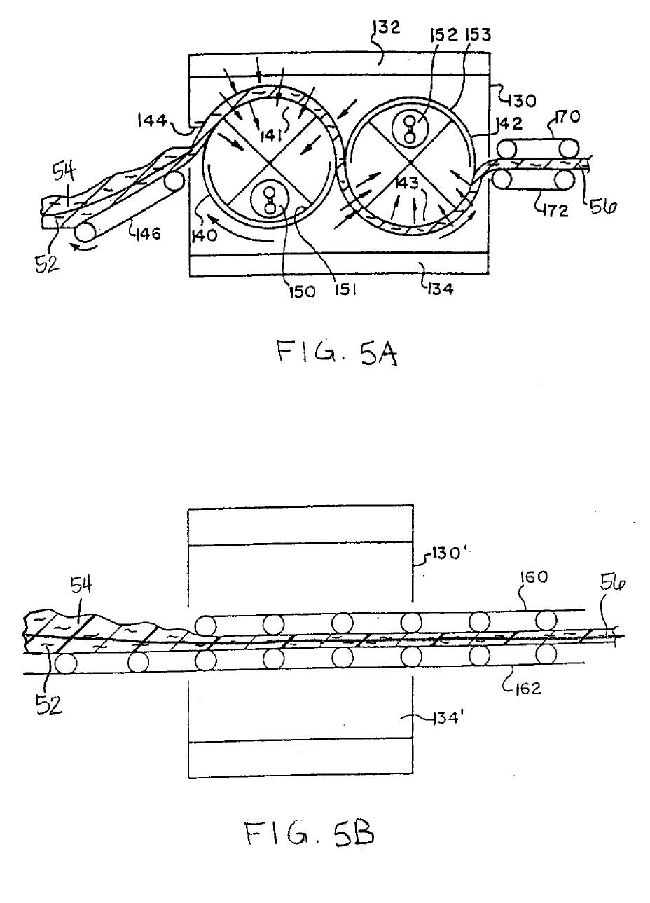

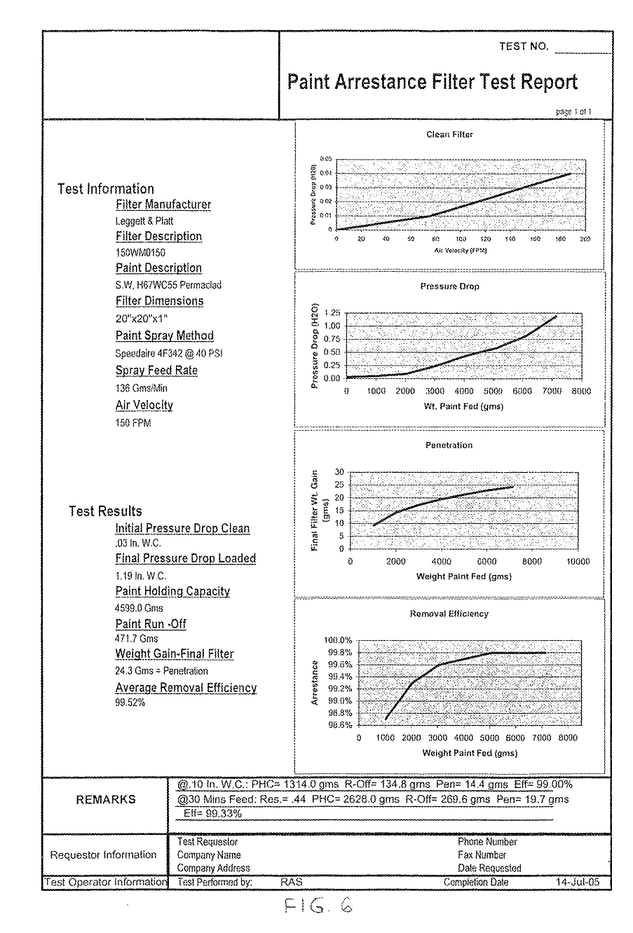

The conveyor 120 then transports the stacked webs 52, 54 to a housing 130 for heating and optional mechanical and/or vacuum compression per 82 of method 70. While there are a variety of heating and compression apparatus suitable for the purposes contemplated herein, one such apparatus comprises first and second counter rotating drums 140 and 142 positioned in a central portion of the housing 130 where vacuum pressure is applied through perforations in the drums 140, 142. The first and second counter rotating drums 140 and 142 also heat the webs 52, 54 to the extent necessary to cure the resin in the webs 52, 54 and thereby form a nonwoven fiber batt. In more detail, FIG. 5A depicts a side view of the counter-rotating drums 140, 142 with perforations 141, 143, respectively, positioned in a central portion of the housing 130. The housing 130 also comprises an air circulation chamber 132 and a furnace 134 in an upper portion and a lower portion, respectively, thereof. The first drum 140 is positioned adjacent an inlet 144 though which the stacked webs 52, 54 are fed by an infeed apron 146. A suction fan 150 is positioned in communication with the interior of the first drum 140. The lower portion of the circumference of the first drum 140 is shielded by a baffle 151 positioned inside the first drum 140 such that the suction-creating air flow is forced to enter the first drum 140 through the perforations 141, which are proximate to the upper portion of the first drum 140 as it rotates.

The second drum 142 is downstream from the first drum 140 in the housing 130. The drums 140, 142 can be mounted for lateral sliding movement relative to one another to facilitate adjustment for a wide range of batt thicknesses (not shown). The second drum 142 includes a suction fan 152 that is positioned in communication with the interior of the second drum 142. The upper portion of the circumference of the second drum 142 is shielded by a baffle 153 positioned inside the second drum 142 so that the suction-creating air flow is forced to enter the second drum 142 through the perforations 143, which are proximate to the lower portion of second drum 142 as it rotates.

The coarse fiber web 52 and the fine fiber web 54 are held under vacuum pressure as they move from the upper portion of the rotating drum 140 to the lower portion of the counter rotating drum 142. The furnace 134 heats the air in the housing 130 as it flows from the perforations 141, 143 to the interior of the drums 140, 142, respectively, to cure the resin in the webs 52, 54 to the extent necessary to bind together the fibers in the webs 52, 54 and thereby form a nonwoven fiber batt 56.

An alternative method for heating and compressing the webs 52, 54 to form a nonwoven fiber batt 56 comprises moving the webs 52, 54 through an oven by substantially parallel perforated or mesh wire aprons that mechanically compress the webs 52, 54 and simultaneously cure the resin to thereby form a nonwoven fiber batt 56. In more detail, FIG. 5B depicts a housing 130′ through which the stacked webs 52, 54 move via a pair of substantially parallel perforated or mesh wire aprons 160, 162. The housing 130′ comprises an oven 134′ that heats the webs 52, 54 to cure the resin to the extent necessary to bind together the fibers in the webs 52, 54 and thereby form a nonwoven fiber batt 56.

Regardless of the apparatus and methods used, the webs 52, 54 may be heated to a temperature of between about 150° F. and about 500° F., between about 200° F. and about 400° F., or between about 275° F. and about 325° F. to cure the resin, and the curing time may be between about 30 seconds and about 30 minutes, between about 2 minutes and about 10 minutes, or between about 3 minutes and about 5 minutes.

Referring again to FIG. 4 and FIG. 5A, as the nonwoven fiber batt 56 comprising the two webs 52, 54 exits the housing 130, the nonwoven fiber batt 56 is cooled and optionally compressed per 84 of method 70 using a pair of substantially parallel wire mesh aprons 170, 172. Alternatively, the nonwoven fiber batt 56 may be cooled without being compressed on a single mesh apron (not shown). The aprons 170, 172 are mounted for parallel movement relative to each other to facilitate adjustment for a wide range of nonwoven fiber batt 56 thicknesses. The nonwoven fiber batt 56 comprising the webs 52, 54 can be cooled slowly through exposure to ambient temperature air or, in the alternative, ambient temperature air can be forced through the perforations of one apron 170, through the webs 52, 54 and through the perforations of the other apron 172 to cool the nonwoven fiber batt 56 and set the webs 52, 54 in their compressed state. The webs 52, 54 are maintained in their compressed form upon cooling since the solidification of the resin bonds the fibers together in that state.

After the nonwoven fiber batt 56 is cooled per 84 of method 70, the nonwoven fiber batt 56 move into cutting zone 180 where the lateral edges of the batt are trimmed per 86 of method 70 to a finished width. The batt is then cut transversely to a desired length to form the multiple-layer, multiple-denier nonwoven fiber batt 50.

It is contemplated that other bonding methods, such as mechanical bonding and thermal bonding, may be used to bond the webs 52, 54 together in lieu of the resin bonding method described herein. Mechanical bonding is the process of bonding the webs 52, 54 together without the use of resins, adhesives, or heat. Examples of mechanical bonding methods are needle punching and hydro entanglement. Needle punching is a method for entangling the fibers within the fiber webs 52, 54 together and also to fibers in adjacent fiber webs 52, 54 by passing a plurality of barbed needles through at least one of the fiber webs 52, 54. Hydro entanglement uses streams of high pressure water to entangle the fibers of the webs 52, 54 together and to fibers in the adjacent webs 52, 54. Thermal bonding uses low-melt binder fibers to bind the fibers within each of the fiber webs 52, 54 together and also to fibers in adjacent webs 52, 54. Low-melt binding fibers do not actually melt as the term is generally understood; instead, the low-melt binder fibers become sticky or tacky when heated to a certain temperature. If the webs 52, 54 are to be thermally bonded, the low-melt binder fibers can be blended with the coarse fibers to make a homogeneous blend of coarse fibers and binder fibers. Similarly, the low-melt binder fibers can be blended with the fine fibers to make a homogeneous blend of fine fibers and binder fibers. The fiber blends are then carded into webs 52, 54 as described above. There is no need to apply a resin to the webs 52, 54 if the webs 52, 54 are to be thermally bonded because the binder fibers bind the fibers in the individual webs 52, 54 to each other and to fibers in the adjacent fiber webs 52, 54. The webs 52, 54 are then heated and optionally compressed via apparatus such as those illustrated in FIGS. 5A and 5B where the heat melts the low-melt binder fibers. The resulting nonwoven fiber batt 56 is then cooled and trimmed in the same way that the resin embodiment of the nonwoven fiber batt 56 was cooled and trimmed to form the multiple-layer, multiple-denier nonwoven fiber batt 50. Other nonwoven production methods are equally applicable to form the multiple-layer, multiple-denier nonwoven fiber batt 50 disclosed herein, and the present invention should not be limited to the nonwoven production methods described herein.

The weight, density, and thickness of the multiple-layer, multiple-denier nonwoven fiber batt 50 are determined by, among other factors, the process of compressing the nonwoven fiber batt 56 as it is cooled. The ratio of batt density to batt thickness generally dictates whether the multiple-layer, multiple-denier nonwoven fiber batt 50 is referred to as a densified fiber batt or a high loft fiber batt. For purposes herein, a densified fiber batt has a ratio of weight (in ounces) per square foot to thickness (in inches) greater than about 2 to 1 and/or a density greater than about 1.5 pounds per cubic foot (pcf). For example, a fiber batt that is one foot wide, one foot long, one inch thick and has a weight of three ounces is defined herein as a densified fiber batt. Conversely, a high loft fiber batt has a ratio of weight (in ounces) per square foot to thickness (in inches) of less than about 2 to 1 and/or a density less than about 1.5 pcf. For example, a fiber batt that is one foot wide, one foot long, one inch thick and has a weight of one ounce is defined herein as a high loft fiber batt.

In an alternative embodiment, the multiple-layer, multiple-denier nonwoven fiber batt 50 can be configured to have a fiber denier gradient. More specifically, the layers forming the batt 50 and the fiber types can be configured such that the multiple-layer, multiple-denier nonwoven fiber batt 50 contains fibers having an increasing weight per unit length through the thickness of the multiple-layer, multiple-denier nonwoven fiber batt 50. Such a configuration of fibers with an increasing weight per unit length through the thickness of the fiber batt 50 is referred to herein as a fiber denier gradient. In one embodiment, the fiber denier gradient described herein may be manufactured by creating a plurality of distinct layers similar to the webs 52, 54 described above. Alternatively, the fiber denier gradient can be created in a continuous process by continuously increasing or decreasing the weight per unit length of fibers fed into the web forming apparatus described herein.

### EXAMPLE

A paint arrestance filter comparison test was conducted using the multiple-layer, multiple-denier nonwoven fiber batt 50 described above. The multiple-layer, multiple-denier nonwoven fiber batt 50 comprised two layers, namely a coarse fiber web 52 and a fine fiber web 54, with the coarse fiber web 52 manufactured to be positioned below the fine fiber web 54. The coarse fiber blend comprised a single fiber type, or 100 percent by weight, of Wellstrand® type 944, 100 denier fibers from Wellman, Incorporated. The fine fiber blend comprised a combination of two fiber types, namely 75 percent by weight of the KoSa type T295, 6 denier fibers from KoSa and 25 percent by weight of Hoechst Celanese 2.25 denier fibers. The fine fiber blend was ten times the weight of the coarse fiber blend. A resin binder comprising equal parts of PVA and water was sprayed onto the top of the fine fiber web 54 and a resin binder comprising two parts PVA to one part water was sprayed onto the bottom surface of the coarse fiber web 52. The nonwoven fiber batt 56 was cured in a triple-pass oven at 290° F. to produce a multiple-layer, multiple-denier nonwoven fiber batt 50 having a thickness of 1.5 inches and a weight per unit area of 1.5 ounces per square foot. The multiple-layer, multiple-denier nonwoven fiber batt 50 contained 77 percent fibers and 23 percent resin binder. The sample size was 20 inches by 20 inches by 1 inch.

FIG. 6 presents a paint arrestance filter test report for the product specimen of the aforementioned multiple-layer, multiple-denier nonwoven fiber batt 50, which was compared to the Paint Pockets® product (Comparison Sample #1) available from the Paint Pockets Company and the Paint Peaks™ product (Comparison Sample #2) available from Leggett & Platt of Carthage, Mo. The Paint Pockets® product is a two layer nonwoven product comprising a first nonwoven fiber batt layer with a plurality of apertures therethrough adhered to a second conventional nonwoven fiber batt layer. The Paint Peaks® product is a nonwoven fiber batt with a convoluted surface. Thus, both Comparison Sample #1 and Comparison Sample #2 have three-dimensional surfaces. During the paint arrestance filter test, the paint was applied at a paint spray feed rate of 136 grams per minute and an air velocity of 150 feet per minute. The paint spray applicator was a Speedaire 4F342 operating at 40 pounds per square inch (psi). Table 1 below provides comparative test results measured after 30 minutes of paint feed:

TABLE 1

| | Paint Hold | | | | |
|---|---|---|---|---|---|
| | Capacity | Paint Runoff | Penetration | Efficiency | Initial Resistance |
| Product | (grams) | (grams) | (grams) | (Percent) | (inches of water) |
| Product | 2628.0 | 269.6 | 19.7 | 99.33 | 0.03 |
| Specimen | | | | | |
| Comparison | 2422.2 | 489.9 | 19.1 | 99.35 | 0.05 |
| Sample #1 | | | | | |
| Comparison | 2503.9 | 480.8 | 16.8 | 99.40 | 0.06 |
| Sample #2 | | | | | |

As Table 1 reflects, the filtration performance of the multiple-layer, multiple-denier nonwoven fiber batt 50 meets or exceeds that of nonwoven fiber batt filtration material having three-dimensional surfaces. More specifically, the multiple-layer, multiple-denier nonwoven fiber batt 50 had superior paint hold capacity, paint runoff, penetration, and initial resistance numbers as compared to both Comparison Sample #1 and Comparison Sample #2. In addition, the efficiency of the multiple-layer, multiple-denier nonwoven fiber batt 50 is almost identical to both Comparison Sample #1 and Comparison Sample #2. Thus, the multiple-layer, multiple-denier nonwoven fiber batt 50 has filtration performance at least as good as Comparison Sample #1 and Comparison Sample #2, but without the need to modify the surface of the nonwoven fiber batt to present a three-dimensional surface to the fluid flow.

While various embodiments have been shown and described, modifications thereof can be made by one skilled in the art without departing from the spirit or teaching of this disclosure. The embodiments described herein are exemplary only and are not limiting. Many variations and modifications of the apparatus and methods are possible and are within the scope of the disclosure. Accordingly, the scope of protection is not limited to the embodiments described herein, but is only limited by the claims that follow, the scope of which shall include all equivalents of the subject matter of the claims.

1. A nonwoven fiber product comprising:
a coarse fiber web comprising a plurality of coarse fibers and being substantially free of any fine fibers; and
a fine fiber web comprising a plurality of fine fibers and being substantially free of any coarse fibers;
wherein the coarse fiber web is positioned adjacent to the fine fiber web.

2. The nonwoven fiber product of claim 1 wherein the coarse fiber web and the fine fiber web each comprise substantially flat surfaces.

3. The nonwoven fiber product of claim 1:
wherein the plurality of coarse fibers comprises one or more coarse fiber types; and
wherein the plurality of fine fibers comprises one or more fine fiber types.

4. The nonwoven fiber product of claim 1 wherein the coarse fibers have a weight per unit length of at least about 30 denier.

5. The nonwoven fiber product of claim 1 wherein the coarse fibers have a weight per unit length of between about 50 denier and about 200 denier.

6. The nonwoven fiber product of claim 1 wherein the coarse fibers have a weight per unit length of between about 75 denier and about 125 denier.

7. The nonwoven fiber product of claim 1 wherein the fine fibers have a weight per unit length of at most about 30 denier.

8. The nonwoven fiber product of claim 1 wherein the fine fibers have a weight per unit length of between about 0.1 denier and about 20 denier.

9. The nonwoven fiber product of claim 1 wherein the fine fibers have a weight per unit length of between about 1 denier and about 8 denier.

10. The nonwoven fiber product of claim 1 wherein the amount of fibers in the coarse fiber web is between about 10 percent and about 100 percent of the amount of fibers in the fine fiber web.

11. The nonwoven fiber product of claim 1 wherein the nonwoven fiber product has a fiber denier gradient.

12. A filtration media comprising the nonwoven fiber product of claim 1.

13. The filtration media of claim 12 wherein the filtration efficiency of the nonwoven fiber product is at least about 99 percent.

14. A method of making a nonwoven fiber product, the method comprising:
blending a plurality of coarse fibers into a coarse fiber blend that is substantially free of fine fibers;
blending a plurality of fine fibers into a fine fiber blend that is substantially free of coarse fibers;
forming the coarse fiber blend into a coarse fiber web; and
forming the fine fiber blend into a fine fiber web;
wherein the fine fiber web is formed adjacent to the coarse fiber web.

15. The method of claim 14:
wherein the plurality of coarse fibers comprises one or more coarse fiber types; and
wherein the plurality of fine fibers comprises one or more fine fiber types.

16. The method of claim 14 further comprising:
bonding the coarse fibers in the coarse fiber web; and
bonding the fine fibers in the fine fiber web.

17. The method of claim 16 wherein bonding comprises resin bonding, mechanical bonding or thermal bonding.

18. The method of claim 16 further comprising bonding at least a portion of the coarse fiber web to at least a portion of the fine fiber web.

19. The method of claim 16 further comprising compressing the coarse fiber web and the fine fiber web together.

20. A method for filtering a fluid, the method comprising:
passing a fluid comprising a plurality of particles through a coarse fiber web; and
passing the fluid through a fine fiber web positioned adjacent to the coarse fiber web;
wherein the coarse fiber web and the fine fiber web collectively remove at least about 99 percent of the particles from the fluid.
